(19) United States
(12) Patent Application Publication
(10) Pub. No.: US 2017/0146445 A1
(43) Pub. Date: May 25, 2017

(54) PAPER HYGROSENSOR AND METHOD OF FABRICATION

(71) Applicant: President and Fellows of Harvard College, Cambridge, MA (US)

(72) Inventors: Lakshminarayanan Mahadevan, Brookline, MA (US); Jun Young Chung, Cambridge, MA (US); Hunter King, Somerville, MA (US)

(21) Appl. No.: 15/358,025

(22) Filed: Nov. 21, 2016

Related U.S. Application Data
(60) Provisional application No. 62/257,628, filed on Nov. 19, 2015.

(51) Int. Cl. G01N 19/10; H01H 35/42

(52) U.S. Cl. CPC G01N 19/10; H01H 35/42

(57) ABSTRACT

Specific modifications of one or more portions of a paper structure inhibits reaction by those portions to an external environmental stimulus, such as humidity. Exposure of the modified paper structure to the external environmental stimulus provides a mechanical response in the paper that provides a sensing, switching, and/or motor function.

### CROSS-REFERENCE TO RELATED APPLICATIONS

This application claims the benefit of U.S. Provisional Patent Application Ser. No. 62/257,628, filed Nov. 19, 2015, entitled “Paper Hygrosensor, Hygroswitch, And Hygromotor,” which is incorporated by reference herein in its entirety.

### INCORPORATION BY REFERENCE

Exhibit I attached hereto is a paper entitled “Evaporative microclimate driven hygrometers and hygromotors” authored by Chung, J. Y., King, H., and L. Mahadevan. The content of Exhibit I is incorporated herein by reference in its entirety as though fully set forth.

### FIELD OF THE INVENTION

The present invention generally relates to a hygromorphic material, and more particularly, a hygromorphic material having a modified structure configured for use as a sensor, switch and/or motor.

### BACKGROUND

The ability to effectively measure an environmental parameter or actuate a device relies on a large, reversible response to a small external stimulus. Sensors often utilize the disproportionate trade-off between a small mechanical response and a large change in electrical properties, such as in the case of piezoelectric and capacitive sensors. In order to obtain a reversible, large mechanical response, ancient strategies in biology and recent advances in engineering have utilized soft materials, such as in the actuation of natural and synthetic muscles. A complementary theme in mechanoreception can be found in diverse biological situations involving slender objects which allow small varying lateral strains to cause large changes in shape via bending. Indeed natural examples include the opening/closing of pine cones and curling of wheat awns, and have also inspired artificial analogs for potential engineering applications.

### SUMMARY OF THE INVENTION

According to an aspect of the present invention, a sensor is provided comprising a hygromorphic material having a length, width, height, and thickness. The hygromorphic material has a first shape when exposed to humidity levels ranging between 0 and h₁, wherein h₁ can be equal to zero. Further, at least one portion of the hygromorphic material can be modified to be impermeable to water. Exposure of the hygromorphic material to humidity greater than h₁ results in a change in at least one of the length, width, height, thickness and/or first shape of the hygromorphic material except the at least one portion, thereby providing an indication that the sensor has been exposed to a humidity level greater than h₁.

Hygromorphic materials are known in the art and, thus, any known hygromorphic materials could be used in the practice of the present invention. It is noted that changes in shape to a hygromorphic material may be more easily detected in a relatively thin material, such as a piece of paper. As such, in some embodiments, the hygromorphic material is provided in the form of a thin sheet of the material so that changes in shape (e.g., curling and bending of the sheet) can be more easily detected.

According to various embodiments, the hygromorphic material is paper, which is an inexpensive, versatile, and sustainable material. The change in at least one of the length, width, height, thickness and/or first shape of the hygromorphic material may be reversible. The at least one portion may be modified by coating the at least one portion with one or more materials impermeable to water. The at least one portion may be modified by coating the at least one portion with moisture resistant tape and/or a hydrophobic wax. Exposure of the hygromorphic material to a humidity level greater than h₂ may result in an irreversible change in at least one of the length, width, height, thickness and/or first shape of the hygomorphic material, wherein h₂>h₁. The hygromorphic material may be further provided as a component of a switch, such that a change in one or more of the length, width, height, thickness and/or first shape of the hygromorphic material, except in the at least one portion, triggers the switch, thereby providing an indication that the sensor has been exposed to a humidity level greater than h₁.

According to another aspect, the present invention provides a sensor comprising a piece of paper having a length, width, height, and thickness. The piece of paper has a first shape when exposed to a first range of one or more of pH, temperature and/or ionic strength. Exposure of the piece of paper to one or more of pH, temperature and/or ionic strength outside of the first range results in a change in at least one of the length, width, height, thickness and/or first shape of the piece of paper, thereby providing an indication that the sensor has been exposed to one or more of a pH, temperature and/or ionic strength outside of the first range.

According to another aspect, the present invention provides a method for determining whether a humidity level in a microclimate has increased above a first humidity level ranging between 0 and h₁, wherein h₁ can be equal to zero. The method comprises providing a sensor device comprising a hygromorphic material having a length, width, height, and thickness, the hygromorphic material having a first shape when exposed to the first humidity level, and at least one portion of the hygromorphic material being modified to be impermeable to water. Exposure of the hygromorphic material to humidity greater than the first humidity level results in a change in at least one of the length, width, height, thickness and/or first shape of the hygromorphic material, except in the at least one portion. The method further comprises determining whether one or more of the length, width, height, thickness and first shape of the hygromorphic material has changed, wherein a change in one or more of the length, width, height, thickness and first shape of the hygromorphic material indicates that humidity in the microclimate has increased above the first humidity level.

According to various embodiments, the hygromorphic material is paper. The method may further comprise determining whether the humidity level in the microclimate has increased above a maximum acceptable humidity level hₘₐₓ, wherein exposure of the hygromorphic material to a humidity level greater than hₘₐₓ results in an irreversible change in at least one of the length, width, height, thickness and/or first shape of the hygomorphic material, wherein the method comprises determining whether one or more of the length, width, height, thickness and first shape of the hygromorphic material has irreversibly changed by decreasing the humidity level of the microclimate below hₘₐₓ and determining whether the one or more changes in length, width, height, thickness and/or first shape reverses. Determining whether one or more of the length, width, height, thickness and first shape of the hygromorphic material has changed may be determined visually. The hygromorphic material may be provided as a component of a switch, such that a change in one or more of the length, width, height, thickness and first shape of the hygromorphic material except the at least one portion triggers the switch, thereby providing an indication that the sensor has been exposed to a humidity level above the first humidity level.

According to another aspect, the present invention provides a switch comprising a hygromorphic material having a length, width, height, and thickness, the hygromorphic material having a first shape when exposed to humidity levels ranging between 0 and h₁, wherein h₁ can be equal to zero, and at least one portion of the hygromorphic material being modified to be impermeable to water. Exposure of the hygromorphic material to humidity greater than h₁ results in a change in at least one of the length, width, height, thickness and/or first shape of the hygromorphic material, except in the at least one portion, thereby triggering the switch. According to various embodiments, the hygromorphic material is paper.

Other aspects, embodiments and advantages of the present invention will become readily apparent to those skilled in the art are discussed below. As will be realized, the present invention is capable of other and different embodiments without departing from the present invention. Thus the following description as well as any drawings appended hereto shall be regarded as being illustrative in nature and not restrictive.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIGS. 1A-G illustrate the use of paper as a sensor in moist microclimates, with FIG. 1A schematically illustrating the paper layered on a sponge over a water bath, FIG. 1B schematically illustrating the deflection of the paper relative to the sponge as a result of moisture evaporation, FIG. 1C graphically illustrating the angle of deflection over time, FIG. 1D graphically illustrating the relative humidity for varying heights for two differing ambient humidities, FIGS. 1E-F illustrate predicted full shapes of the paper for the two differing ambient humidities, and FIG. 1G demonstrates the agreement between predicted and measured deflection, according to an embodiment of the present invention.

FIGS. 2A-F schematically illustrate two different paper hygromotor designs according to embodiments of the present invention, with FIGS. 2A and 2C illustrating the structure and resulting motion of the two paper hygromotors, FIG. 2B graphically illustrating position of one edge as a function of time for the FIG. 2A paper hygromotor, FIG. 2D graphically illustrating progress of directed motion as a function of time for the FIG. 2B paper hygromotor, FIG. 2E showing snapshots of directed motion over time for the FIG. 2B paper hygromotor, and FIG. 2F showing snapshots of directed motion over time for the FIG. 2C paper hygromotor.

FIGS. 3A-B schematically illustrate strain gradient due to humidity gradient for flat and curved paper, according to an embodiment of the present invention.

FIG. 4 illustrates two small pieces of paper of differing thickness and their reaction over time after placement on a moist sponge.

### DETAILED DESCRIPTION OF THE INVENTION

The present invention provides new hygrosensor, hygroswitch, and hygromotor designs which provide a large mechanical response that is reversible and predictable. In particular, the present invention utilizes paper configured in such a way that it responds to a local moisture gradient near an evaporative surface. The paper configuration is such that the response provides a sensing, switching, and/or motor function. In alternative embodiments, the present invention utilizes paper configured in such a way that it responds to one or more of pH, temperature and/or ionic strength so as to provide a sensing, switching, and/or motor function.

In particular, the present inventors found that a natural candidate for a responsive slender structure that might serve as a sensor, actuator or source of motion is paper. As a disordered material, paper derives its rigidity from entanglement and adhesion of its composite fibers. The athermal and frictional nature of its relatively large fibers (length≈1 mm, diameter≈10 μm) fundamentally distinguishes its response from otherwise analogous thermal polymeric solids. Indeed, the relation to these solids is similar to that between jammed granular systems and molecular glasses.

During the fabrication of paper, the alignment of fibers along the direction of deposition by fluid leads to a marked mechanical anisotropy. This, together with the fact that cohesion between composite cellulose fibrils is mediated by inter- and intra-molecular hydrogen bonds sensitive to stimuli such as humidity, heat, solvent concentration, and ionic strength, means that varying these parameters leads to expansion or contraction of the network, preferentially in the direction perpendicular to the alignment direction. Though typical strains may be small, strain gradients across the thickness can lead to large out-of-plane deflections.

Paper generally tends to respond to moisture by curling. For example, a thin sheet of paper placed on one's palm curls as it swells on one side in response to the exudation of moisture from the skin. This reaction to moisture is a commonly observed inconvenience for conventional uses of paper as a flat substrate, and is one that the industry goes to great lengths to minimize. By understanding the mechanics of paper's response to moisture (as well as pH, temperature and/or ionic strength) and manipulating the geometry of paper, it becomes possible to form paper sensors that can extract environmental information based on the shape of the paper upon exposure to moisture of other target environmental factor(s). In addition, by applying moisture (as well as pH, temperature and/or ionic strength) to a paper structure in a controlled manner, a mechanical response can be produced that is capable of performing useful work. Still further, exposure of a paper structure to moisture (as well as pH, temperature and/or ionic strength), either in a controlled manner or merely as a result of natural environmental factors, can produce a change in the paper structure that allows it to be incorporated in or function as a switch.

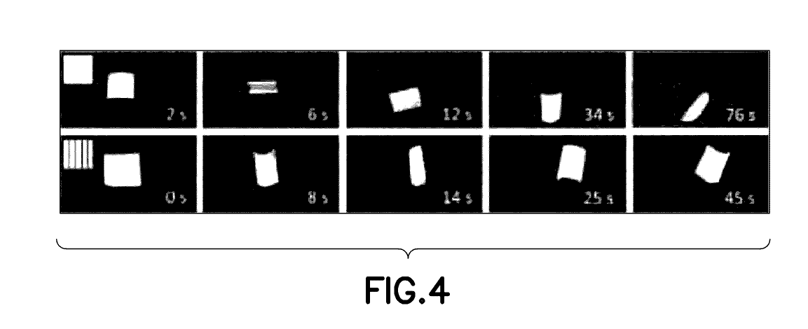

In FIG. 4 two small pieces of paper each about a 50 mm square, a lightweight yellow paper (top—lightweight yellow tracing paper, Alvin; basis weight=31 g m-2; thickness≈30 μm) and a heavyweight white paper (bottom—White weighing paper, VWR Scientific Products; basis weight=39 g m-2; thickness 40 μm), were placed on a moist sponge having a size of 540 mm×420 mm and a thickness of 25 mm with 500 mL of pure water from which water evaporates at a controlled rate. As shown, in both cases, the paper spontaneously curls and bends upwards from the edges. Both pieces of paper preferentially bend perpendicular to the fiber alignment. This effect is more pronounced in the heavier paper, which has greater fiber alignment. Eventually the paper curls over so strongly that it tips over its edge and flips upside down, exposing the drier side to moisture, and the process repeats itself. This reproducible, reversible nature is in marked contrast to the irreversible curling of paper that occurs on a water surface, but is similar to that observed in engineered polymer films that can harvest energy from humidity.

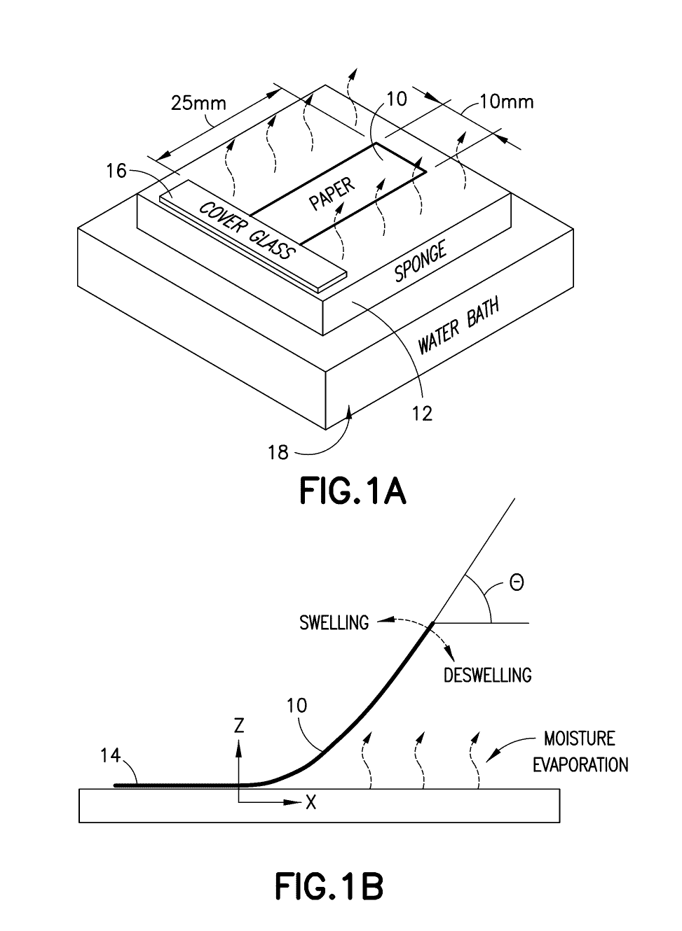

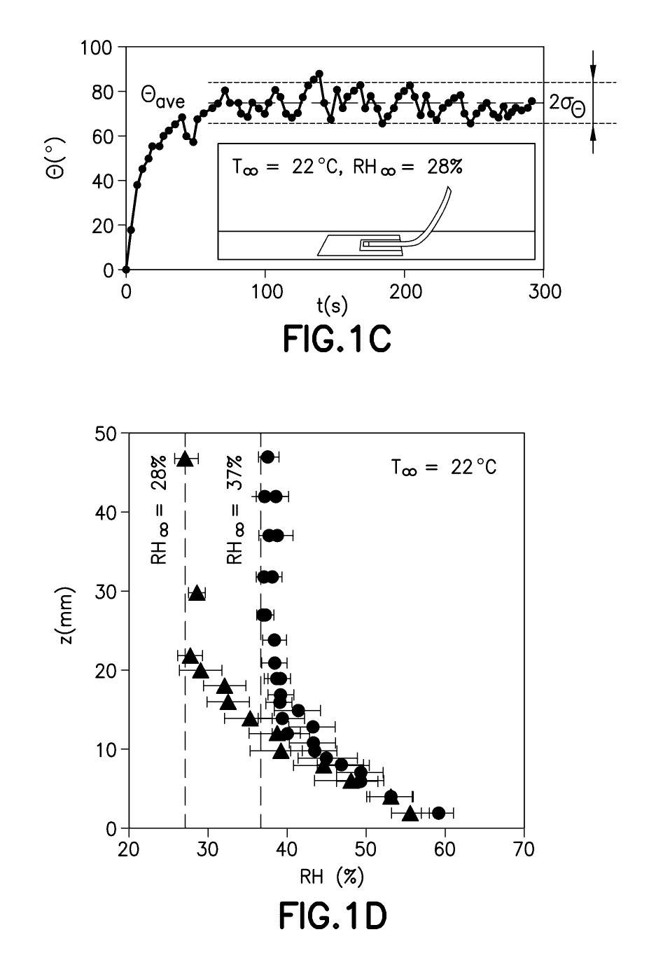

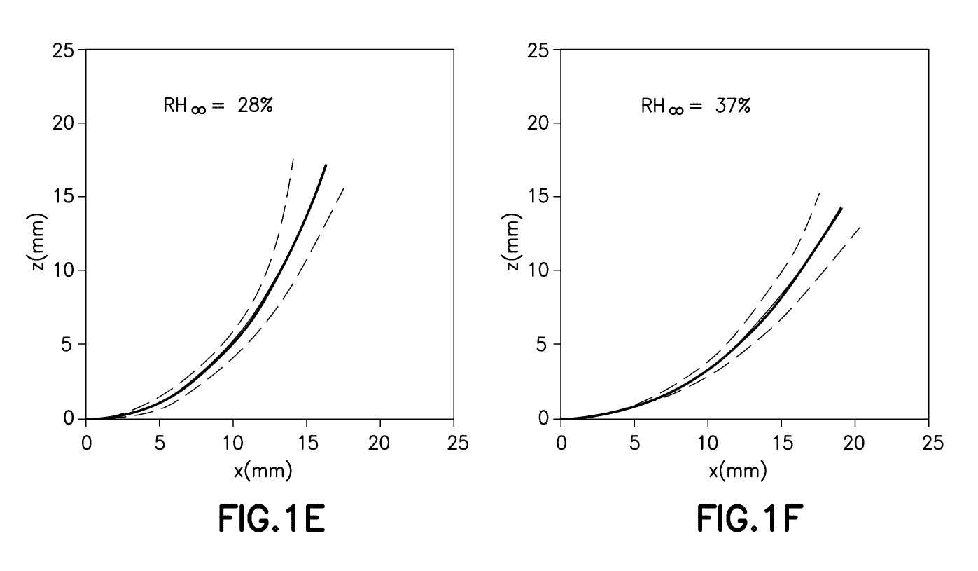

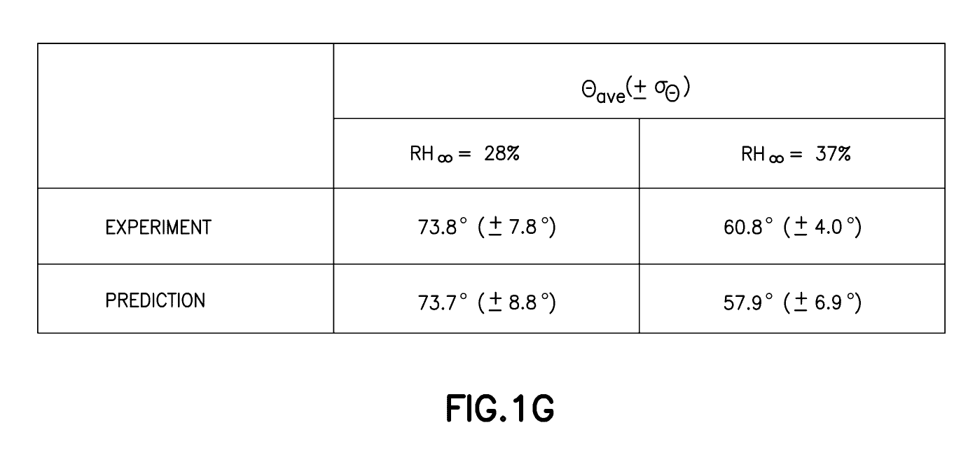

FIGS. 1A-G illustrate an experimental setup in which paper is utilized as sensor in a moist microclimate according to one embodiment of the invention. As shown in FIG. 1A, an initially flat piece of paper 10 is placed on a sponge 12 and is fixed at one edge to form a cantilever. In particular, in this embodiment, the paper 10 is fixed at the left edge 14 with a piece of glass 16. The remainder of the paper 10 is thus free to move about this fixed edge relative to the sponge 12 below. The sponge 12 is wetted from below by placing it over a water bath 18, and the bottom surface of the paper 10 is then exposed to moisture from the sponge 12. This exposure to moisture causes uneven expansion through the thickness of the paper 10 (since exposure is from the bottom surface) and results in subsequent bending of the paper 10 away from the horizontal axis of the paper 10.

In the experimental setup above, white weighing paper (VWR Scientific Products; basis weight=39 g m-2; thickness≈40 μm), cover glass (Cover Glass No. 1 (22 mm×50 mm), Corning; thickness 150 μm), and an open cell, polyurethane foam sponge were used. A small piece of the weighing paper was chosen as the main test sample for its highly anisotropic nature exhibiting different mechanical properties in its principal directions due to preferential fiber orientation

FIGS. 1B-C show the change in deflection B with time in the open-air environment with ambient temperature T_{∞} of 22.4±0.2° C. and relative humidity H_{∞} of 28.3±1.4%. As shown, the paper is initially flat at time t=0. Gradually, the free end bends upward making an angle θ with the horizontal, eventually reaching well-defined average value (in this case, θₐᵥₑ≈74°, and then fluctuating around this angle with a deviation σ_{θ}.

The curvature of the paper is greatest nearest the surface and decreases near its free end (see FIGS. 1B and 1C inset), which fluctuates owing to a varying local humidity associated with the varying microclimate. To characterize this microclimate, the relative humidity profile H(z) normal to the surface is measured (without paper) for identical surface preparations, but on days with significantly variable ambient relative humidity H_{∞}, measured with a small capacitive humidity sensor, as shown in FIG. 1D. That the relative humidity does not reach 100% at the near surface of a moist sponge is consistent with the fact that its free volume is not saturated with liquid water.

These relative humidity measurements were used as inputs in a model to predict the full shape of the corresponding paper cantilevers, as shown in FIGS. 1E and 1F. FIG. 1G demonstrates the agreement between predicted and measured deflection. In particular, in predicting the deformed shape of the paper cantilever, the equation:

$$κ = \frac{d ɛ}{d \tilde{z}} = \frac{α}{h} Δ H .$$

was applied to the measured average humidity profiles: κ(z)=(α/h)ΔH(z), where ΔH(z)≈[Hₐᵥₑ(z)±σH(z)]−H_{∞} (approximating the paper as impermeable to vapor transport on time scales associated with bending), and σH (z) is the fluctuating part of the relative humidity. Though the approximation somewhat underestimates both H₁, because moisture does accumulate under the paper, and H₂, because some moisture is transported to the top, it provides a relatively more accurate estimate of the difference ΔH, which ultimately determines local curvature.

The form of the curvature κ(z) with a fixed boundary condition at x=0: z(x=0)=0 and dz/dx(x=0)=0, where α is a free parameter, was then used to best fit the image of the cantilever in FIG. 1E, having measured the thickness (h=40 μm). The result yields α=1.02×10-4, consistent with values in the literature. The same value was applied to the predicted curve in FIG. 1F, for which the measured humidity was significantly different. The predicted standard deviation curves, shown in FIGS. 1E-F by the dashed curves, were generated using the measured values of σH(z).

The agreement between predicted and measured cantilever shapes for two sets of environmental conditions with one common fitting parameter indicates that, despite the large variation in both measured humidity and bending angle, the average values of each can be meaningfully related to each other through the simple model. That the predicted deviation curves reasonably bound the variation shown in the images (indicated by σθ in FIG. 1C) suggests that the cantilever shape simply follows the change in relative humidity, which is, in turn, sensitive to fluctuations in air flow.

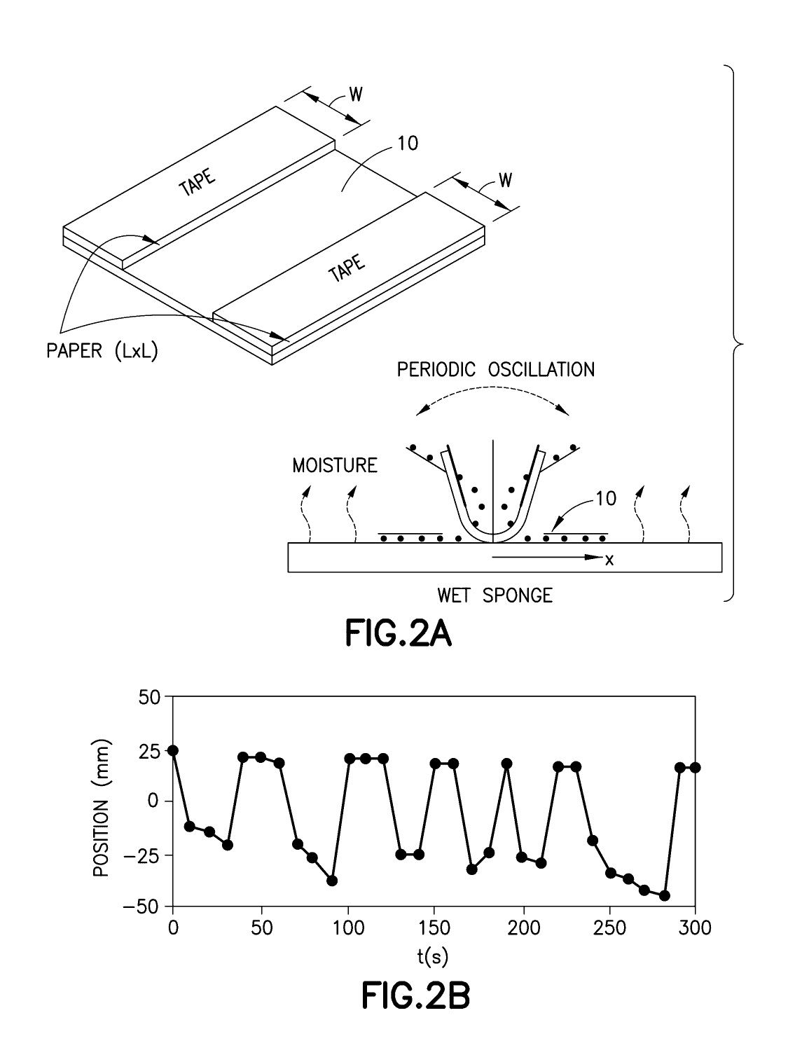

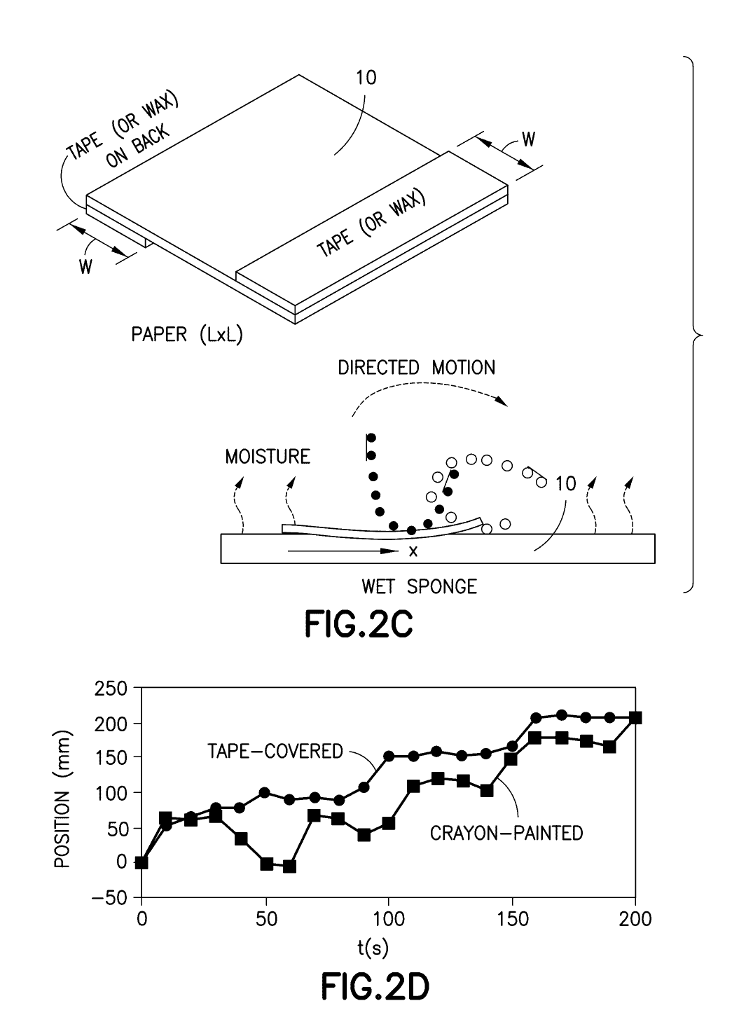

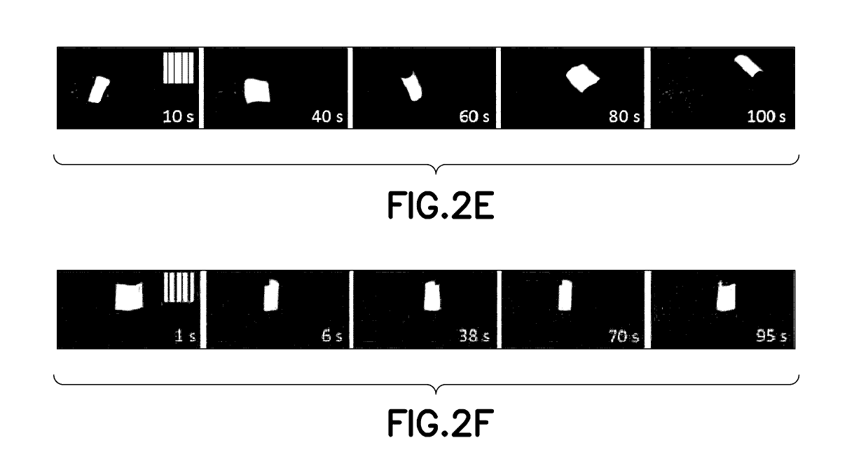

The above demonstrates how a uniform hygroscopic material (here, paper) can be used as a simple measure of the evaporative microclimate near a moist surface. According to further embodiments, paper structures can be fabricated to perform mechanical work using the energy harnessed from evaporation. In particular, by modifying one or both surfaces of a hygroscopic material, such as paper, to inhibit absorption or expansion at those modified surfaces, a hygro-oscillator and a hygromotor, such as those shown in FIGS. 2A and 2B, can be provided. In addition, a hygroswitch could similarly be provided.

As shown in FIG. 2A, by partially coating a strip of paper along two opposite edges with a piece of moisture-resistant tape (adhesive tape, Scotch Magic Tape, 3M; basis weight=65 g m-2; thickness≈50 μm) (or through any other modification technique that provides a moisture barrier at these edges), and depositing the resultant paper structure onto a moist surface, a hygro-oscillator is formed. As shown in FIG. 2B, this structure first bends upward symmetrically due to the swelling of the paper just below the taped edges. However, this U-shaped state is not stable and tips over into a C-shape (or its mirror image). This C-shape then flattens out due to drying, before the whole process is repeated. These rocking side-to-side oscillations have an average period τₚ, the typical time required to bend the sheet into a U starting from a flat sheet (the time to tip over is much smaller than the time to bend the sheet). In typical lab conditions, τₚ≈τ_{b}≈50 s (see FIGS. 2A, 2B, 2F). Thus, according to one aspect of the present invention, the surface of a flat piece of paper is modified to make the curling response spatially non-uniform across the surface to provide a symmetric, periodic rocking—or oscillating—motion. The position of one edge of the paper as a function of time is plotted in FIG. 2B.

As shown in FIG. 2C, the paper is modified asymmetrically to yield a rocking motion that is biased to produce directed motion. In this embodiment, a glide-flip symmetry is provided by coating the top of one edge of the paper and the bottom of the opposite edge with a piece of tape (or through any other modification technique that provides a moisture barrier at these edges). In this embodiment, as only one edge of the side of the paper in contact with the moist surface is free to swell, the strip bends over and eventually loses stability as it is shaped into a C (or its mirror image), and flips over. Because of the lack of up-down symmetry, the same process when repeated leads to net motion. The time for flipping once the strip bends strongly is small compared to the time for bending; therefore the period of motion is determined by the time for bending into a C. This leads to discontinuous motor trajectories with a period for flipping τₚ≈50 s. This, again, is consistent with the time for a paper cantilever to bend in the microclimatic boundary layer (FIG. 1C), and yields an average velocity determined by the length of the strip, i.e., ≈3.5 cm/50 s=0.7 mm s⁻¹. This effect can also be achieved even more simply by replacing the tape with a thin layer of hydrophobic paraffin wax from a crayon or the like (see FIG. 2D). Progress as a function of time is plotted in FIG. 2D and images of that progress are shown in FIG. 2E. As depicted in this embodiment, modifying the paper causes selective hygroexpansion of the uncovered (hydrophilic) parts of the paper, which moves the contact line towards the preferred direction (from left to right in this case), which consequently leads to locomotion by rolling.

As depicted by the motion of the modified papers (FIGS. 2A and 2C), within a broad range of humidity, the expansion of the paper structure is reversible and linear. The local curvature is determined by only two material parameters, the thickness and hygroscopic expansion coefficient of the paper, and the difference in relative humidity on either side of the paper. These factors give the paper hygro-sensor/motor wide application potential.

The average period of turnover τₚ for both types of modified paper is nearly the same and is comparable to the characteristic time τ_{b} needed to reach the quasi-stationary curl in paper (FIG. 1C). Since the bending dynamics of the paper is strongly regulated by substrate properties, placing a paper actuator onto a moist surface with a higher Ts or salinity will cause it to either speed up or slow down. The relative width of the moisture barrier (e.g., tape or wax covered portion) compared to the half-width of the paper 2 W/L is another factor that affects motor parameters such as frequency and velocity, although it is not as significant as the humidity variation. There is an optimal ratio of 2 W/L for maximizing the motor efficiency, as either limit is poorly behaved: if 2 W/L˜1, the paper sheet cannot bend enough to tip or flip over so that it remains relatively stable, while if 2 W/L<<1, the asymmetry disappears.

Curling of bilayer objects due to non-uniform expansion is a known phenomenon. Frustration between layers caused by thermal expansion of bi-metal thermostats or hygroexpansion of bilayer tissues in biological systems is partially relaxed by a predictable curling response. By contrast, the paper hygro-sensor/switch/motor of the present invention is not a bilayer system and functions ideally with no frustration, as the curled state relaxes the linear strain gradient.

Irreversible curling of uniform paper wet by liquid water has also been understood in terms of bilayer expansion, where an expanded wet layer and unexpanded dry layer are separated by the liquid-vapor interface within its thickness. The paper hygro-sensor/switch/motor, by contrast, reversibly curls in response to a linear gradient in concentration of water vapor within its thickness.

### Hygroexpansion Induced Curvature

As noted above, interactions between cellulose fibrils that compose paper are mediated largely by inter- and intramolecular hydrogen bonds. Absorption of moisture from the air changes the number of these bonds and affects the interaction between fibers, leading to expansion or contraction of the network. In the range of relative humidity RH between from 20% to 65%, paper is known to reversibly and linearly absorb water and expand with strain ε in response to local humidity with a material-dependent, hygroscopic expansion coefficient α:

ε=αRH

Due to the fabrication process, in which fibers settle and align more along the machine direction than the cross-machine direction, paper's material properties are generally anisotropic and the expansion coefficient is larger in the cross-machine direction.

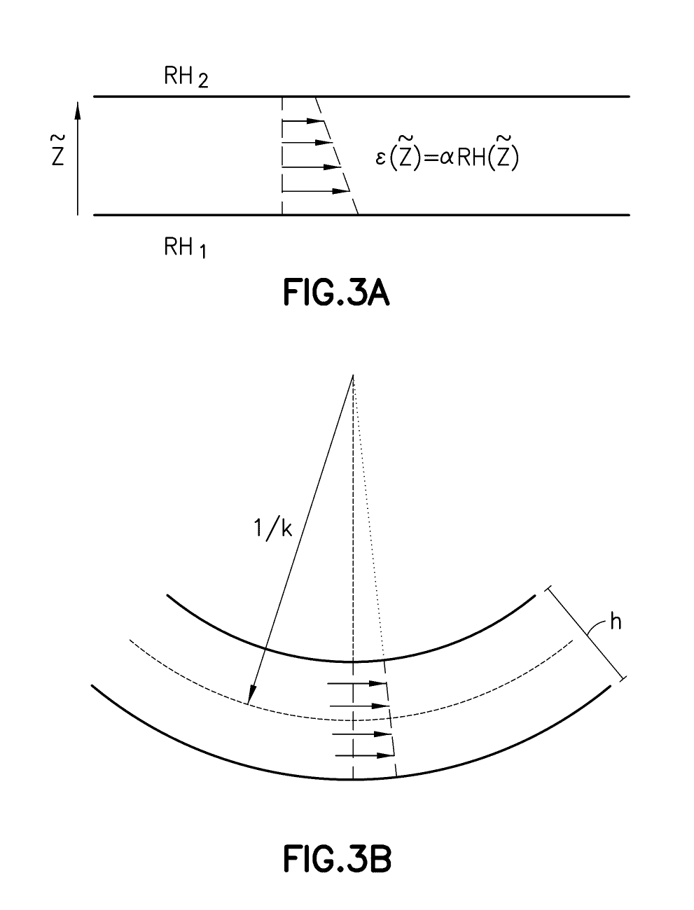

FIG. 3 (comprising FIG. 3A and FIG. 3B) illustrates the schematic of a curved paper. If a cross-section of paper finds itself between two regions of differing relative humidity, RH₁>RH₂, the strain from expansion will clearly be non-uniform across the thickness. Note that the subscripts 1 and 2 refer respectively to the bottom (close to the moist surface) and top sides of the paper. Taking the paper as a uniform medium, the humidity gradient, and therefore the strain ε within the paper, should be linear:

$$R H ( \tilde{z} ) = R {H}_{1} - \frac{Δ R H}{h} \tilde{z} \to \frac{d ɛ}{d \tilde{z}} = α \frac{Δ R H}{h}$$

where ΔRH=RH₁−RH₂, h is the thickness, and \tilde{z} is the direction perpendicular to the paper surface, as illustrated in FIG. 3A. Small arrows represent internal strains caused by the expansion gradient in the uncurved paper.

The strain profile of a slightly curved (unstretched) sheet is naturally linear with a slope equal to the curvature κ.

$$\frac{d ɛ}{d \tilde{z}} = \frac{d}{d \tilde{z}} ( \frac{{s}^{′}}{s} ) = \frac{1}{R θ} \frac{d {s}^{′}}{d r} = \frac{1}{R θ} \frac{d ( r θ )}{d r} = \frac{1}{R} ≡ κ$$

where

$$\frac{{s}^{′}}{s}$$

is the strain expressed as arclengths on either side of the midline Rθ and \tilde{r}=\tilde{z} is chosen locally as the out-of-plane direction. By buckling out of plane, the non-uniformly expanded paper can find a curvature which exactly matches its strain profile, and thus relaxes stress, as illustrated in FIG. 3B. Then, the curvature is equated with the hygroscopic strain gradient, which yields:

$$\frac{d ɛ}{d \tilde{z}} = κ = α \frac{Δ R H}{h}$$

It is important to note that curvature has no dependence on average expansion, as the paper is allowed to expand freely along its length.

Humidity Gradient from Evaporation

Localized humidity gradients characterize the non-equilibrium “microclimate” near a moist surface. Vapor is constantly flowing away toward an effectively infinite bath, transported primarily by diffusion near the surface, and by convection at larger distances. The resulting average humidity profile depends on flow patterns, geometry of the surface, and ambient humidity.

Paper should buckle due to a humidity gradient of any origin, but typically small expansion coefficients necessitate an unnaturally sharp gradient to produce significant curvature. The responsiveness of the hygrosensor is partly a result of the paper's influence on the gradient into which it is placed. Though the paper is relatively porous, the transport of vapor is strongly hindered by its presence, which acts to enhance the difference on either side, and in turn, the response of the sensor.

### Realization of Hygro-Fueled Paper Machines

The mechanical response described above as a simple means of extracting environmental information can as easily be used as novel actuating mechanism for paper devices, in which energy is harnessed from evaporation. By non-uniformly modifying the surface of paper to inhibit absorption or expansion, shape change can further be manipulated toward a useful end, such as locomotion.

In some embodiments, paper hygromotors can be experimentally constructed using moisture-resistant tape or crayon or any other hydrophobic material or coating. By partially coating a sheet of ordinary paper with a piece of tape (as described in connection with FIG. 2A), rolling is inhibited, and symmetric oscillatory bending occurs at an average frequency. On the other hand, directed motion is realized by applying asymmetric modifications (as described in connection with FIG. 2C).

Paper is one of the most common, versatile, environmentally sustainable, and least expensive materials known to humankind, but its use has traditionally been limited as a medium for writing, printing, and packaging. Only recently has paper been considered for use as a platform for engineered devices, such as microfluidics, biosensors, flexible energy and electronic devices.

The present invention provides new applications and uses of ordinary paper. In particular, by modifying paper so as to provide selective areas that respond to moisture (or, in some embodiments, pH, temperature and/or ionic strength), a smart material with sensing and actuating capabilities can be provided. Using specific modifications, the mechanical response of the modified paper structure can be reversibly and predictably caused by a local moisture gradient near an evaporative surface (or a local pH, temperature and/or ionic strength gradient). As such, the present invention provides sensors, switches, and motors that can be fabricated cheaply and easily, using a material having millennia-old engineering history, ubiquity, and renewability. By understanding the mechanics or paper, and manipulating the geometry of a piece of paper, environmental information can be extracted from the shape of the paper when it is placed in the environment. Further, even slight modifications of paper allow for simple and efficient ways of realizing humidity-powered oscillatory and directed motions (as well as pH, temperature and/or ionic strength—powered oscillatory and directed motions). Beneficially, this framework allows for a mild environment in which changes to the paper are fully reversible—a key criterion in sensor and actuator development.

The ubiquity of paper in engineering means that the potential applications of the present invention are nearly limitless. For example, the paper hygrosensor according to the present invention is a uniquely simple, cheap, and renewable solution for measuring the humidity gradient which characterizes non-equilibrium microclimates very near evaporative surfaces. Such microclimates are found, for example, near a perspiring skin or a transpiring leaf. Because the humidity gradient depends on internal properties of the living system, such as sweat salinity or pore concentration, the paper hygrosensor could have important applications in medicine, biology, and environmental monitoring.

Apart from providing a simple means for cheaply and sensitively measuring the external and internal environmental factors, the unique mechanical response of paper that exhibits curling, bending, oscillating and/or rolling can further be utilized in a multitude of engineering applications. In particular, a paper hygromotor can provided that can utilizes, for locomotion, a common environmental variable—humidity gradient. The crawling paper described above is a novel example of converting the entropic gain of evaporating moisture directly into mechanical work.

In the present invention, commercial paper was used as a predictable sensor and motor that can respond mechanically and dynamically to a moisture gradient stimulus. As any non-planar behavior in paper is considered undesirable, the industry goes to considerable lengths to diminish curling in response to moisture. By only slightly—yet very specifically—modifying paper, dramatic improvements in sensing and actuating functions can be achieved. Furthermore, while the exemplary embodiments described herein utilize humidity as the primary external stimulus which influences the mechanical response of paper, the present invention is not limited only to changes in humidity. Rather, in addition to humidity, other external stimuli, including but not limited to, changes in pH, temperature, and/or ionic strength, can be utilized in providing a desired response in a modified paper structure so as to provide a paper-sensor/switch/motor.

Functionality performed by the present system and method may be performed by a computer. The functionality of the present system and method can be implemented in software, firmware, hardware, or a combination thereof. Generally, in terms of hardware architecture, the computer includes a processor, a memory, a storage device, and one or more input and/or output (I/O) devices (or peripherals) that are communicatively coupled via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software, particularly that stored in the memory, as described herein. The processor can be any custom made or commercially available processor, a central processing unit (CPU), an auxiliary processor among several processors associated with the computer, a semiconductor based microprocessor (in the form of a microchip or chip set), a macroprocessor, or generally any device for executing software instructions.

The memory can include any one or combination of volatile memory elements (e.g., random access memory (RAM, such as DRAM, SRAM, SDRAM, etc.)) and nonvolatile memory elements (e.g., ROM, EFPROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the processor.

Specific to the present system and method, software in the memory may include one or more separate programs or modules, each of which comprises an ordered listing of executable instructions for implementing logical functions of the present system and method, as described below. In addition, the memory may contain an operating system (O/S) or any other module required. The operating system essentially controls the execution of computer programs and provides scheduling, input-output control, file and data management, memory management, and communication control and related services.

If a computer is used, the modules within the memory may provide functionality for notifying a user of the present system and method when a state of a switch is obtained. For instance, prior density, length, width, and other variables of a hygromorphic material may be predefined for purposes of comparison by the computer. In addition, specific ranges of these variables may be predefined for notifying a user, thereby providing a switch environment.

It should be noted that while the abovementioned refers to the storage device being within the computer, in accordance with an alternative embodiment of the invention, the storage device may be removable, or be a device separate from the computer that may be connected to the computer for use in accordance with the present system and method.

The functionality of the computer may be provided by a source program, executable program (object code), script, or any other entity containing a set of instructions to be performed. When a source program, then the program needs to be translated via a compiler, assembler, interpreter, or the like, which may or may not be included within the memory, so as to operate properly in connection with the O/S. Furthermore, the functionality of the computer can be written as (a) an object oriented programming language, which has classes of data and methods, or (b) a procedure programming language, which has routines, subroutines, and/or functions.

The I/O devices may include input devices, for example but not limited to, a keyboard, mouse, touchscreen, microphone, or other input device. Furthermore, the I/O devices may also include output devices, for example but not limited to, speakers, monitors (e.g., touchscreens), or other output devices. Finally, the I/O devices may further include devices that communicate via both inputs and outputs, for instance, but not limited to, a modulator/demodulator (modem; for accessing another device, system, or network), a radio frequency (RF) or other transceiver, a telephonic interface, a bridge, a router, or other device.

The storage device may be any block data storage device, such as, but not limited to, hard disks or hard drives, optical discs, NAND flash memories, or any storage device capable of maintaining a sequence of bytes or bits having a nominal length (block size).

When the computer is in operation, the processor is configured to execute the software stored within the memory, to communicate data to and from the memory, and to generally control operations of the computer pursuant to the software. The software and the O/S, in whole or in part, but typically the latter, are read by the processor, perhaps buffered within the processor, and then executed.

When the functionality of the computer is implemented in software, it should be noted that the functionality can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The functionality of the computer can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where the functionality of the computer is implemented in hardware, the computer can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be noted that the computer may contain separate modules, wherein each module contains functionality for execution. As previously mentioned, functionality of the present system and method can be implemented in software, firmware, hardware, or a combination thereof.

The components, steps, features, objects, benefits and advantages that have been disclosed above are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages.

Nothing that has been stated or illustrated is intended to cause a dedication of any component, step, feature, object, benefit, advantage, or equivalent to the public. While the specification describes particular embodiments of the present application, those of ordinary skill can devise variations of the present application without departing from the inventive concepts disclosed in the disclosure.

In the present application, reference to an element in the singular is not intended to mean “one and only one” unless specifically so stated, but rather “one or more.” All structural and functional equivalents to the elements of the various embodiments described throughout this disclosure, known or later come to be known to those of ordinary skill in the art, are expressly incorporated herein by reference.

What is claimed is:

1. A sensor comprising:
a hygromorphic material having a length, width, height, and thickness;
the hygromorphic material having a first shape when exposed to humidity levels ranging between 0 and h₁, wherein h₁ can be equal to zero; and
at least one portion of the hygromorphic material being modified to be impermeable to water;
wherein exposure of the hygromorphic material to humidity greater than h₁ results in a change in at least one of the length, width, height, thickness and/or first shape of the hygromorphic material except the at least one portion, thereby providing an indication that the sensor has been exposed to a humidity level greater than h₁.

2. The sensor of claim 1, wherein the hygromorphic material is paper.

3. The sensor of claim 1, wherein the change in at least one of the length, width, height, thickness and/or first shape of the hygromorphic material is reversible.

4. The sensor of claim 1, wherein the at least one portion is modified by coating the at least one portion with one or more materials impermeable to water.

5. The sensor of claim 1, wherein the at least one portion is modified by coating the at least one portion with moisture resistant tape and/or a hydrophobic wax.

6. The sensor of claim 1, wherein exposure of the hygromorphic material to a humidity level greater than h₂ results in an irreversible change in at least one of the length, width, height, thickness and/or first shape of the hygomorphic material, wherein h₂>h₁.

7. The sensor of claim 1, wherein the hygromorphic material is further provided as a component of a switch, such that a change in one or more of the length, width, height, thickness and/or first shape of the hygromorphic material except the at least one portion triggers the switch, thereby providing an indication that the sensor has been exposed to a humidity level greater than h₁.

8. A sensor comprising:
a piece of paper having a length, width, height, and thickness;
the piece of paper having a first shape when exposed to a first range of one or more of pH, temperature and/or ionic strength; and
wherein exposure of the piece of paper to one or more of pH, temperature and/or ionic strength outside of the first range results in a change in at least one of the length, width, height, thickness and/or first shape of the piece of paper, thereby providing an indication that the sensor has been exposed to one or more of a pH, temperature and/or ionic strength outside of the first range.

9. A method for determining whether a humidity level in a microclimate has increased above a first humidity level ranging between 0 and h₁, wherein h₁ can be equal to zero, comprising:
providing a sensor device comprising:
a hygromorphic material having a length, width, height, and thickness;
the hygromorphic material having a first shape when exposed to the first humidity level;
at least one portion of the hygromorphic material being modified to be impermeable to water;
wherein exposure of the hygromorphic material to humidity greater than the first humidity level results in a change in at least one of the length, width, height, thickness and/or first shape of the hygromorphic material except the at least one portion; and
determining whether one or more of the length, width, height, thickness and first shape of the hygromorphic material has changed, wherein a change in one or more of the length, width, height, thickness and first shape of the hygromorphic material indicates that humidity in the microclimate has increased above the first humidity level.

10. The method of claim 9, wherein the hygromorphic material is paper.

11. The method of claim 9, further comprising determining whether the humidity level in the microclimate has increased above a maximum acceptable humidity level hₘₐₓ, wherein exposure of the hygromorphic material to a humidity level greater than hₘₐₓ results in an irreversible change in at least one of the length, width, height, thickness and/or first shape of the hygomorphic material, wherein the method comprises determining whether one or more of the length, width, height, thickness and first shape of the hygromorphic material has irreversibly changed by decreasing the humidity level of the microclimate below hₘₐₓ and determining whether the one or more changes in length, width, height, thickness and/or first shape reverses.

12. The method of claim 9, wherein determining whether one or more of the length, width, height, thickness and first shape of the hygromorphic material has changed is determined visually.

13. The method of claim 9, wherein the hygromorphic material is further provided as a component of a switch, such that a change in one or more of the length, width, height, thickness and first shape of the hygromorphic material except the at least one portion triggers the switch, thereby providing an indication that the sensor has been exposed to a humidity level above the first humidity level.

14. A switch comprising:
a hygromorphic material having a length, width, height, and thickness;
the hygromorphic material having a first shape when exposed to humidity levels ranging between 0 and h₁, wherein h₁ can be equal to zero; and
at least one portion of the hygromorphic material being modified to be impermeable to water;
wherein exposure of the hygromorphic material to humidity greater than h₁ results in a change in at least one of the length, width, height, thickness and/or first shape of the hygromorphic material except the at least one portion, thereby triggering the switch.

15. The switch of claim 14, wherein the hygromorphic material is paper.
